(19) United States
(12) Patent Application Publication
(10) Pub. No.: US 2009/0132312 A1
(43) Pub. Date: May 21, 2009

(54) REGULATORY COMPLIANCE SYSTEM AND METHODOLOGY FOR PAYDAY LOANS TO MILITARY SERVICE MEMBERS AND THEIR DEPENDENTS

(75) Inventors: Thomas Reinheimer, Jacksonville, FL (US); Nathan Groff, Jacksonville, FL (US)

Correspondence Address: MARK YOUNG, P.A., 12086 FORT CAROLINE ROAD, UNIT 202, JACKSONVILLE, FL, 32225, US

(73) Assignee: Veritec Solutions, LLC, Jacksonville, FL (US)

(21) Appl. No.: 12/180,559

(22) Filed: Jul. 27, 2008

Related U.S. Application Data
(63) Continuation-in-part of application No. 11/941,972, filed on Nov. 19, 2007.

(51) Int. Cl. G06Q 10/00; G06Q 50/00

(52) U.S. Cl. 705/7; 705/30

(57) ABSTRACT

A computer-implemented method for credit transaction legal compliance includes creating a user account for a user; providing a source of law data applicable to credit transactions by the user; receiving credit transaction data for a transaction by the user; automatically comparing the credit transaction data for the transaction by the user with the law data applicable to the credit transaction by the user; and determining whether the credit transaction data for the transaction by the user complies with the law data applicable to the credit transaction by the user. A computer-implemented system for credit transaction legal compliance includes a module for creating a user account for a user; a module for providing a source of law data applicable to credit transactions by the user; a module for receiving credit transaction data for a transaction by the user; a module for automatically comparing the credit transaction data for the transaction by the user with the law data applicable to the credit transaction by the user; and a module for determining whether the credit transaction data for the transaction by the user complies with the law data applicable to the credit transaction by the user. The system and method determine if a borrower is a covered member under laws and regulations protecting active military personnel and their spouses and dependents.

### RELATED APPLICATION

This application is a continuation in part and claims the benefit of priority of pending U.S. nonprovisional application Ser. No. 11/941,972, filed Nov. 19, 2007, the entire contents of which are incorporated herein by this reference.

### FIELD OF THE INVENTION

This invention generally relates to credit transactions, and more particularly, to an automated system and method for determining whether a transaction complies with then-current applicable laws and regulations, including laws and regulations protecting military service members and their dependents, notifying a lender of the outcome of the determination and maintaining a database of transaction information.

### BACKGROUND

Many individuals, particularly low-wage earners, rely very heavily upon check cashing services to process their paychecks and cash advance services to manage their finances. Businesses that provide such services are an extremely valuable resource to consumers with limited liquidity and access to conventional banks. For millions of consumers, these services are a way of life. Consequently, the number of outlets offering these types of services has grown dramatically in recent years. People in need have turned such outlets into a kind of alternative banking sector.

While these outlets fill a void, they suffer several shortcomings. For example, such outlets are labor-intensive and susceptible to human error. Heretofore, outlets have struggled with monitoring and interpreting applicable laws and regulations and applying the rules to transactions. Under the status quo, monitoring is typically ad hoc, interpretations are varied, and compliance is spotty at best.

Regulation of such lending institutions had previously been handled primarily by individual states, although federal regulations and rules have recently been passed to address perceived abuses and impacted groups, particularly military personnel and their families. The growing payday loan industry is now perched atop an active and shifting legal landscape. Lenders lobby to enable payday lending practices, while opponents of the industry lobby to prohibit the high cost loans in the name of consumer protection. The applicable governing laws vary widely from state to state, with some states banning such lending transactions while other states have chosen to limit and regulate them. The applicable laws also vary depending upon the borrower's status.

When not explicitly banned, state laws that prohibit payday lending are usually in the form of usury limits, i.e., transaction fee caps. Some states have laws limiting the number of loans a borrower can take at a single time. Some states also cap the number of loans per borrower per year, or require that after a fixed number of loan-renewals or consecutive loans, the lender must offer a lower interest loan with a longer term or provide a waiting period, so that the borrower can eventually get out of the debt cycle. Some borrowers attempt to circumvent these laws by taking loans from more than one lender. Further complicating the lender's job, these limitations are in a state of flux, frequently changing along with associated reporting and recordkeeping requirements. The ever changing regulations and lack of centralization (i.e., lack of a centralized database) make it difficult or impossible for lending staff to comply with the laws and regulations.

In response to payday lenders targeting military personnel and the resulting harm to military personnel well-being, quality of life and readiness, Congress's Armed Service Committee included § 670 in the John Warner National Defense Authorization Act. The resulting statute, codified at 10 U.S.C. § 987 (2006) and entitled “Terms of Consumer Credit Extended to Service Members and Dependents: limitations” sets forth limitations on lenders who provide loans to military personnel and their dependants (“covered members”). The law also required that the Secretary of Defense to prescribe regulations for the enforcement of these limitations by Oct. 1, 2007. Limitations on Terms of Consumer Credit Extended to Service Members and Dependents, 72 Fed. Reg. 18, 157 (Apr. 11, 2007) (to be codified at 32 C.F.R. pt. 232).

The new federal statute and the DOD regulations limit the interest required on extensions of credit to military personnel and their dependants to what is agreed to under the credit agreement, what is authorized by applicable State or Federal law, and what is not specifically prohibited by the law itself, and no more than a 36% annual percentage rates for credit extended to covered members. In addition, the DOD regulations specifically define a military annual percentage rate (“MAPR”) to include the following cost elements that are deducted from the proceeds of the credit extended to covered members: “interest, fees, credit service charges, credit renewal charges, credit insurance premiums including charges for single premium credit insurance, fees for debt cancellation or debt suspension agreements, and fees for credit-related ancillary products sold in connection with and either at or before consummation of the credit transaction.” The regulations, however, provide that the MAPR is not to include fees imposed for actual unanticipated late payments, default or delinquency; because these are fees imposed as a result of contingent events occurring after the loan is consummated.

The new military statute requires that any extension of credit to a covered member, including those extended through the internet, shall provide adequate disclosures of the applicable annual percentage rate, any disclosures already required under the Truth in Lending Act, and a clear description of the payment obligations. Such disclosures are to be made orally and in writing, and shall be in accordance with the regulations implementing the Truth in Lending Act, which require a separate written itemization of the amount financed, unless the consumer is made aware that he is entitled to such an itemization and declines it. The DOD proposed regulations further specify that certain disclosures must be made clearly and conspicuously prior to completion of the credit transaction, including the applicable MAPR and its corresponding total dollar amount, a clear description of the payment obligations, and a statement expressly identifying the special protections provided and alternatives available to military personnel under the Army Emergency Relief, Navy and Marine Corps Relief Society, Air Force Aid Society or Cost Guard Mutual Aid, including free legal advice upon request. The regulations clarify that written disclosures must be made in a form the covered borrower can retain a copy of, and that oral disclosure requirements may be met in the case of internet or mail transactions by providing a toll-free telephone number.

Furthermore, the new military statute provides for several restrictions on the terms that can appear in loans to covered members and the way in which they can be maintained. First, the law bans the rollover, renewal, refinancing, or consolidation of loans extended to covered members with the proceeds of other credit. Loans to covered members may not require them to waive any of the rights to legal recourse they enjoy as service members. Likewise, the statute bans the use of mandatory arbitration clauses in such loans. It also bans the use of checks, access to deposit accounts, allotments, savings, or the title of vehicles as security for loans extended to covered members. Additionally, the statute states that covered members will be given the chance to pay off their loans early, without incurring prepayment penalties.

Penalties are imposed for violating the new military statute and regulations. Both the statute and the DOD regulations state that a creditor who knowingly violates these provisions can be charged with a misdemeanor, and the credit agreement resulting from such prohibited actions will be void from inception. The statute also provides that no agreement to arbitrate a dispute over the extension of consumer credit will be enforceable against any covered member.

The new military statute and regulations coupled with the ever-changing landscape of state statutes and regulations create a veritable minefield for payday lenders. Not only must a lender ascertain compliance with state laws, but a lender must also determine whether a borrower is a military service member or dependent, i.e., a “covered member” as protected by the new military statute and regulations.

The invention is directed to overcoming one or more of the problems and solving one or more of the needs as set forth above.

### SUMMARY OF THE INVENTION

As used herein, the term “transaction” is used to broadly cover any credit transaction, including, but not limited to deferred presentment transactions, such as payday loan and cash advance transactions. Additionally, as used herein, the terms “laws” and “regulations” broadly mean any cases, statutes, regulations, ordinances, rules, executive orders and other legal obligations and restrictions imposed by a governing body. Furthermore, the term “regulatory compliance” means the acting according to applicable laws and regulations.

To overcome one or more of the problems and solve one or more of the needs as set forth above, a computer-implemented method for credit transaction legal compliance is provided. An exemplary method includes creating a user account for a user; providing a source of law data applicable to credit transactions by the user; receiving credit transaction data for a transaction by the user; automatically comparing the credit transaction data for the transaction by the user with the law data applicable to the credit transaction by the user; and determining whether the credit transaction data for the transaction by the user complies with the law data applicable to the credit transaction by the user. The step of providing a source of law data applicable to credit transactions by the user may include reviewing a source of law data, determining and encoding requirements from the law data, including a transaction fee limit and a number of loans (i.e., number of transactions) limit. The step of providing a source of law data may include associating law data with a state identifier and storing the law data and state identifier. The step of providing a source of law data may include periodically reviewing the law data. History of updates to the law data may be maintained. The step of creating a user account for a user may include receiving and storing lender information input from a user, the lender information including facility identification information. Ownership entity and facility identification information (e.g., the state(s) in which the owner entity and lending facility are located) is associated with credit transaction data for the transaction, thus enabling the governing state law to be determined. The credit transaction data includes all fields required to ensure compliance, such as borrower information, a transaction type datum, owner entity information, lender facility location information, a transaction date, a transaction amount, a transaction fee, an agreement date, a due date, a deposit date, a closed date, and a return date. Applicable legal requirements are determined based upon the credit transaction data, particularly facility location information. The step of automatically comparing the credit transaction data for the transaction by the user with the law data applicable to the credit transaction includes comparing transaction data for the credit transaction with a maximum allowable transaction data, and/or comparing a credit transaction number for a borrower with a maximum legal number of credit transactions for a borrower, and/or comparing the credit transaction data for the transaction by the user with the law data applicable to the credit transaction includes comparing a credit transaction number for a borrower for a determined period of time with a maximum legal number of credit transactions for a borrower for a determined period of time. An approval determination is based upon the comparison of the credit transaction data for the transaction by the user with the law data applicable to the credit transaction by the user, with the determination being approved if the credit transaction data complies with the law data applicable to the credit transaction and the determination being failed if the credit transaction data complies with the law data applicable to the credit transaction.

To overcome one or more of the problems and solve one or more of the needs as set forth above, a computer-implemented system for credit transaction legal compliance is provided. An exemplary system includes a module for creating a user account for a user; a module for providing a source of law data applicable to credit transactions by the user; a module for receiving credit transaction data for a transaction by the user; a module for automatically comparing the credit transaction data for the transaction by the user with the law data applicable to the credit transaction by the user; a module for determining whether the credit transaction data for the transaction by the user complies with the law data applicable to the credit transaction by the user, a module configured to communicate the results of the comparison (i.e. the compliance status of the transaction) back to the user, and a history module configured to store user session data such as queries, responses and input information to provide a compliance audit trail. The module for providing a source of law data applicable to credit transactions by the user is configured to provide access to a source of law data, determine and encode requirements from the law data, including, but not limited to, a maximum transaction fee and a number of loans limit. A module for providing a source of law data may include associating law data with a state identifier and storing the law data and state identifier. A module for providing a source of law data may include periodically reviewing the law data. History of updates to the law data may be maintained. A module for creating a user account for a user may include receiving and storing lender information input from a user, the lender information including facility identification information. Ownership entity and facility identification information (e.g., the state in which the facility is located) is associated with credit transaction data for the transaction, thus enabling the governing state law to be determined. The credit transaction data includes borrower information, a transaction type datum, lender facility location information, a transaction date, a transaction amount, a transaction fee, an agreement date, a due date, a deposit date, a closed date, a return date and other fields as required to effectively ensure that the transaction complies with applicable law, a transaction fee, an agreement date, a due date, a deposit date, a closed date, a return date and other fields as required to effectively ensure that the transaction complies with applicable law. Applicable legal requirements are determined based upon the credit transaction data, particularly facility location information. A module for automatically comparing the credit transaction data for the transaction by the user with the law data applicable to the credit transaction is configured to compare transaction data for the credit transaction with a maximum legally allowable transaction data, and/or compare a credit transaction number for a borrower with a maximum legal number of credit transactions for a borrower, and/or compare the credit transaction data for the transaction by the user with the law data applicable to the credit transaction includes comparing a credit transaction number for a borrower for a determined period of time with a maximum legal number of credit transactions for a borrower for a determined period of time, and/or if a transaction is determined to be “consecutive” compare the number of consecutive loans with legal limits. By way of example and not limitation, Oklahoma considers a loan conducted within 7 days of closing a prior loan to be consecutive and requires a 48 hour waiting period after the 5th consecutive loan. Thus, compliance assessment entails determining whether a loan is a 6^{th} consecutive loan, and, if so, whether there has been 48 hour wait. A module for approval determination is configured to base a determination upon the comparison of the credit transaction data for the transaction by the user with the law data applicable to the credit transaction by the user, with the determination being approved if the credit transaction data complies with the law data applicable to the credit transaction and the determination being failed if the credit transaction data complies with the law data applicable to the credit transaction.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides a high level block diagram of components of an exemplary regulatory compliance system according to principles of the invention; and

FIG. 2 provides a high level flowchart of steps of an exemplary regulation update process according to principles of the invention; and

FIG. 3 provides a high level flowchart of steps of a user registration process according to principles of the invention; and

FIG. 4 provides a high-level flowchart of steps of a compliance checking process according to principles of the invention.

Those skilled in the art will appreciate that the Figures are not intended to illustrate every implementation of the invention. Specifically, the invention is not limited to the exemplary implementations, system, components, processes, steps or order of steps depicted in the Figures.

### DETAILED DESCRIPTION

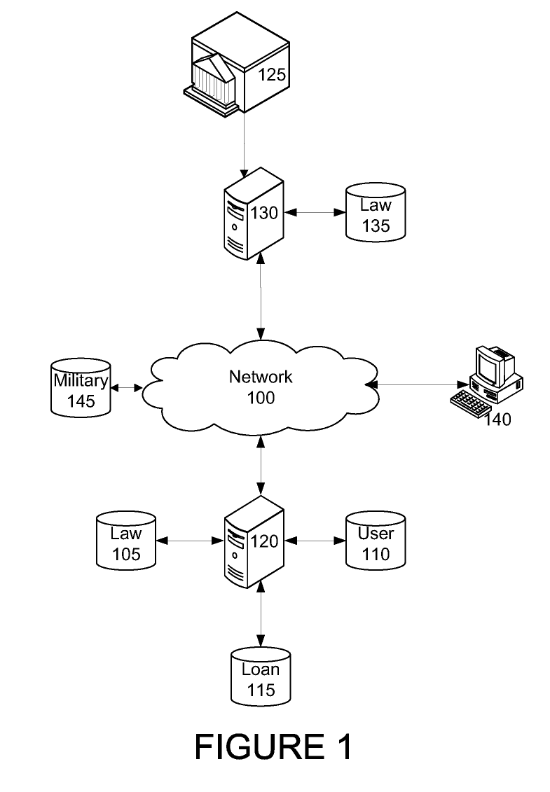

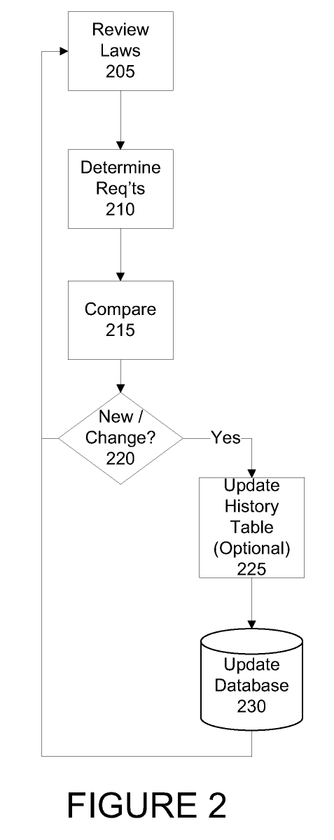

In an exemplary implementation of the invention, an automated system and method for determining whether a transaction complies with then-current applicable laws and regulations, notifying a lender of the outcome of the determination and maintaining a database of transaction information are provided. FIG. 1 provides a high level block diagram of components of an exemplary regulatory compliance system according to principles of the invention. FIGS. 2 through 4 provide high-level flowcharts of exemplary regulation monitoring, user registration, and compliance processes according to principles of the invention.

Referring first to FIG. 1, a high level block diagram of components of an exemplary regulatory compliance system according to principles of the invention is shown. One or more governing bodies 125, such as a legislative and executive branch, regulatory agency and/or court establishes, by enactment, promulgation, ruling or otherwise, laws that govern credit transactions and lenders. The laws may be accessible in a conventional manner, such as in printed form or electronically via one or more computers 130 and one or more data sources 135. The one or more computers 130 may be accessible over a communications network 100.

Optionally, a service provider monitors the laws and maintains a database 105 of codes corresponding to the laws. As used herein, database means a source of data, including any organized body of related information. A server 120 hosts software for storing data and performing functions according to the invention. Users (e.g., lenders) using computing devices 140 access the server 120 to register and determine if a transaction complies with applicable laws. Access to the server 120 by the user 140 is preferably via one or more data communications networks 100, which may include the Internet.

An exemplary server 120 is comprised of one or more computer systems, each having a bus for communicating information, a central processing unit (CPU), a read only memory (ROM), a random access memory (RAM), a mass storage device, and communications equipment. The storage device may include a hard disk, CD-ROM drive, DVD drive, tape drive, memory (e.g., RAM, ROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as network operating system software may be stored on and executable on the server. These elements are typically included in many computer servers. Indeed, the aforementioned servers are intended to represent a broad category of computer systems capable of functioning as a computer server and hosting application software for network access and use and database management in accordance with the present invention. Of course, the server 120 may include fewer, different and/or additional elements, functioning as single servers or as a distributed system, provided they are capable of performing functions in accordance with the present invention.

The server 120 hosts (i.e., provides clients with access to) information, documents and software needed to provide functionality and enable performance of methodologies in accordance with an exemplary embodiment of the invention. For example, the server 120 may include web page information and documents (e.g., scripts, HTML and XML code), applets and application software, which manage subscriber access and use, processes transactions and manage databases for subscriber data.

The server 120 may be responsible for accepting HTTP requests from client Web browsers, and serving the requester HTTP responses along with optional data contents, which usually are Web pages such as HTML documents and linked objects (images, etc.). The HTTP response typically consists of an HTML document, but can also be a raw text file, an image, or some other type of script, document, applet, file, message or information. The Web server may have the capability of logging detailed information, about client requests and server responses, to log files, allowing the Webmaster to collect statistics by running log analyzers on log files. Such statistics may be used for security monitoring and to optimize performance.

One or more database servers may be provided to run a database management system (DBMS) which provides functionality, namely, managing and querying the databases 105, 110 and 115. The databases 105, 110 and 115 may be separate or integrated data stores, i.e., structured collections of records or data stored in a computer so that the database management system can consult it to answer queries.

A plurality of users (i.e., lenders) directly or indirectly access the server 120 using compatible computing devices 140 with network connectivity. By way of example, such end-user computing devices 140 may include personal computers, personal digital assistants or any similarly equipped electronic computing devices. Although one user computer 140 is shown for illustrative purposes, any number of user computers may be used in accordance with the invention. Additionally, various forms of network connectivity may be used by the user computers 140 to access the server 120. Subscriber system may include an operating system and a web browser configured to process data sent by the server system.

Those skilled in the art will appreciate that a system according to the invention can utilize many different types of communications networks 100. For example, a proprietary Wide Area Network (WAN) or a public WAN such as the Internet may be used. These networks typically employ various protocols such as the HyperText Transfer Protocol (HTTP), Extensible Markup Language (XML), and Transfer Control Protocol/Internet Protocol (TCP/IP) to communicate information between remote computer systems. A system according to the present invention may also utilize wireless networks, including those utilizing Global System for Mobile (GSM), Code Division Multiple Access (CDMA) or Time Division Multiple Access technology, and the Wireless Application Protocol (WAP). A system according to the invention may utilize any or any combination of, such communications networks and new network technologies hereafter developed.

A firewall may be located between each server 120, 130, and the network 100 to protect against corruption, loss, or misuse of data. The firewall limits access by the user computers 140 and prevents corruption of data. Thus, the user computers 140 may access and receive only data that is deemed necessary and authorized according to firewall settings. The firewall may be integrated within the servers 120, 130 as software, firmware or a hardware component, or constitute another system component, or reside as a standalone component.

The processes, functions and/or algorithms described herein are implemented in hardware, software or a combination of software and hardware in one embodiment. The software comprises computer executable instructions encoded in a computer readable media. Further, such functions correspond to modules, which are software, hardware, firmware, or any combination thereof. Multiple functions are performed in one or more modules as desired, and the embodiments described are merely examples. The software is executed on a digital signal processor, application-specific integrated circuit, microprocessor, or other type of processor operating on a system, such as a personal computer, server, a router, or other device capable of processing data including network interconnection devices. Some embodiments may implement the functions in two or more specific interconnected hardware modules or devices with related control and data signals communicated between and through the modules, or as portions of an application-specific integrated circuit. Thus, the exemplary process flow is applicable to software, firmware, and hardware implementations.

The databases 105-115, 145 contain a comprehensive collection of legal, user and loan data as well as military personnel and dependent data and other relevant data arranged, organized, indexed and/or retrievable based on name, address, social security number, driver's license number and/or other identifying criteria. An administrator of the system acquires the legal data from the legal data source 135. The law database contains information, codes and data corresponding to applicable federal, state and local government laws including statutes, regulations, ordinances and orders. By way of example and not limitation, such laws may include applicable statutes and regulations governing lending to active military personnel and their dependents, e.g., “Terms of Consumer Credit Extended to Service Members and Dependents: Limitations,” 10 U.S.C. § 987 and “Limitations on Terms of Consumer Credit Extended to Service Members and Dependents,” 72 Fed. Reg. 18, 157 (Apr. 11, 2007) (to be codified at 32 C.F.R. pt. 232). The loan database 115 comprises loan data obtained from user input for each transaction. The user database 110 comprises user (i.e., lender) data obtained from lenders during registration and account maintenance. Each item of data acquired and entered into a database 105-115, 145 is associated with a particular address, geographical region, user, transaction, session or other identifier. When a report is requested as discussed herein, available records indexed by the same address, geographical region or other identifier are selected.

The military database 145 comprises data for determining whether a borrower is a “covered member,” i.e., an active member of the military, a spouse of an active member or a dependent. By way of example and not limitation, the military database 145 may comprise The Defense Integrated Military Human Resources System, which is an enterprise wide human resources database system for the United States Department of Defense, and/or any of the many legacy systems that provide current human resources information for military personnel within the various agencies, departments and offices comprising the for the United States Department of Defense. The military database 145 is maintained by or on behalf of the military and made directly or indirectly accessible to users 145 for purposes of determining if a borrower is a “covered member,” i.e., an active member of the military, a spouse of an active member or a dependent. In the event a borrower is a covered member, then the applicable laws and regulations governing lending to active military personnel and their dependents apply. Such laws may include “Terms of Consumer Credit Extended to Service Members and Dependents: Limitations,” 10 U.S.C. § 987 and “Limitations on Terms of Consumer Credit Extended to Service Members and Dependents,” 72 Fed. Reg. 18, 157 (Apr. 11, 2007) (to be codified at 32 C.F.R. pt. 232).

The separate databases are shown for reference convenience to conceptually illustrate three different categories of data. While the databases are conceptually illustrated as three separate distinct databases in the Figures, those skilled in the art will appreciate that two or more of the databases may be combined, included together or separately in a larger database, or further subdivided into smaller component databases. The invention is not limited to any particular data or database structures.

The databases 105-115, 145 may be any conventional database capable of effectively storing collections of records in an organized accessible manner to permit efficient easy access to desired pieces of data, i.e. one or more records, for example, associated with a particular property, using appropriate database management system software. The data may be obtained and updated online or off-line, in real-time or in batch mode.

The exemplary system populates the legal database 105 with legal data. Legislative bodies and legal reporting services (e.g., Westlaw® and Lexis®) maintain public records of statutes, rules, regulations, case law and executive orders pertaining to lenders and credit transactions, referred to herein as law or applicable law. In most cases, the legal information is available electronically form a data source 135 via a server 130. Such records typically include the reporting, record-keeping and due diligence obligations of lenders, as well as the requirements for a lawful and proper transaction. Data corresponding to such obligations and requirements is determined from the law reporting database 135, entered into the database 105 and associated with a state.

The process for entering/updating a law record starts with reviewing the source of law data 125, 135, e.g., via server 130, as in step 205 of FIG. 2. Before law information is entered into the law database 105, the requirements are determined and encoded, as in step 210 of FIG. 2. By way of example, the database 105 may include a field for disclosure requirements, which may comprise a code that identifies information that must be disclosed to borrowers. The database 105 may include a field for recordkeeping in years, which is a field that indicates how many years a lender must maintain records of a transaction, the value of which may be zero or greater. Other fields may indicate interest rate caps, the number of loans a borrower can take at a single time, the number of loans per borrower per year, codes corresponding to limitations on terms and conditions applicable to a borrower, etc. . . . Yet other fields may indicate reporting requirements in years. The determined encoded data is then compared with existing information in the database for the associated state, as in step 215 of FIG. 2. If the data is new or changed, each field entry that is new or changed may be copied to a history table (or other means or managing history data), as in optional step 225, and then the record is updated as in step 230. Subsequently, control may be passed to step 205 to continue periodic review of the laws. The history table maintains a record of all updates to the legal database, which can be used for compliance checking over a period of time. If the data is not new or changed 220, the database is maintained and control may be passed to step 205 to continue periodic review of the laws.

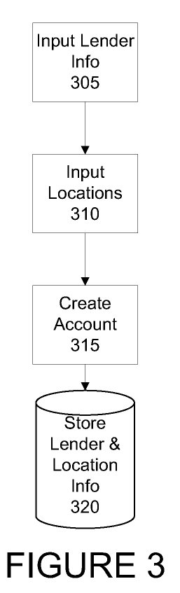

Referring now to FIG. 3, a high level flowchart of steps of a user registration process according to principles of the invention is conceptually shown. The registration process entails receiving lender information (e.g., name, principal address, contact information) input by a user (e.g., lender), as in step 305. Other information (e.g., billing information) may be also be required. Location information for each facility of the lender is provided, as in step 310. The system then creates an account for the lender, as in step 315. The account information, including the lender and facility information, is stored in a user database 110, as in step 320. Online login and update tools may be provided to allow lenders password protected access to their account information, for purposes of updating their account. Thus, the system stores lender and facility information, which can be associated with each transaction.

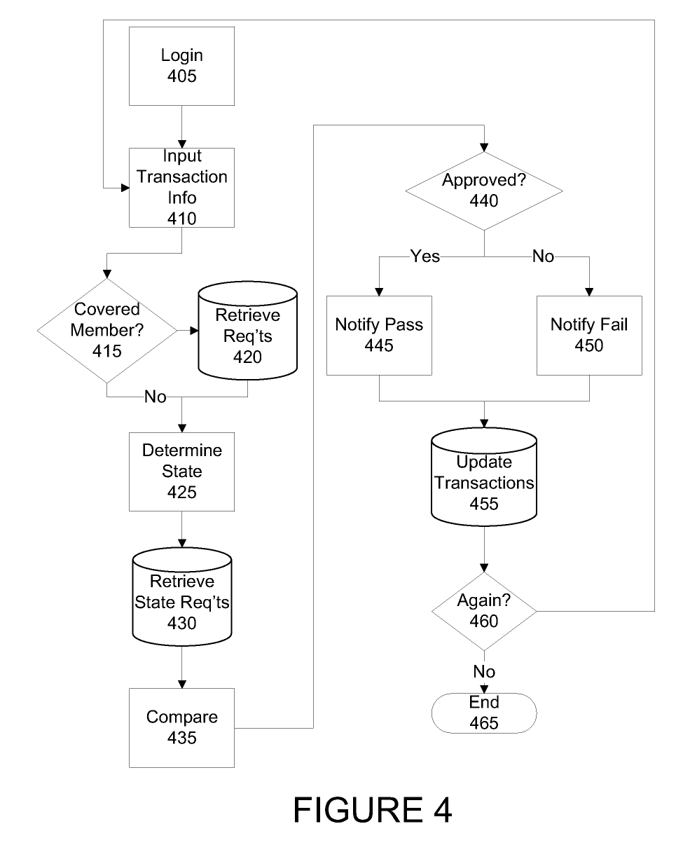

FIG. 4 provides a high-level flowchart of steps of a compliance checking process according to principles of the invention. The process entails logging in, preferably through a password protected interface, as in step 405. Logging in serves to identify the user, facility and company, while preventing access by unauthorized entities and users. After logging in, transaction information is entered, as in step 410. The transaction information includes borrower information, the type of transaction, the facility from which the transaction is being processed, the date, the amount of the transaction, the interest rate, all fees associated with the transaction, and any other relevant information. Based upon the input information, covered member status may be determined, as in steps 415. If a borrower is a “covered member,” i.e., an active member of the military, a spouse of an active member or a dependent, then the applicable laws and regulations governing lending to active military personnel and their dependents apply. Such laws may include “Terms of Consumer Credit Extended to Service Members and Dependents: Limitations,” 10 U.S.C. § 987 and “Limitations on Terms of Consumer Credit Extended to Service Members and Dependents,” 72 Fed. Reg. 18, 157 (Apr. 11, 2007) (to be codified at 32 C.F.R. pt. 232). In such case, the requirements for compliance with applicable laws and regulations governing lending to active military personnel and their dependents are determined in step 420. Additionally, based upon the input information, the state and applicable legal requirements may be determined, as in steps 425 and 430. Then the requirements (i.e., state requirements and, if applicable, covered member requirements) are compared with the transaction information to assess compliance, as in step 435. By way of example, the interest rate may be compared with interest rate caps, the number of loans for the borrower may be determined from the transaction database and/or user input and compared with the number of loans a borrower can take at a single time under applicable law, the number of loans for the borrower may be determined from the transaction database and/or user input and compared with the number of loans for that borrower over the past determined period of time (e.g., year), disclosure requirements may be compared with disclosures, other contractual limitations and requirements may be compared with terms and conditions, etc. . . . Based upon the comparisons, an approval determination is made, as in step 440. If the input data and previously stored data reveal no conflict with the legal requirements, the transaction may be approved and a notification of approval may be communicated to the user 140, as in step 445. If the input data and previously stored data reveal a conflict with the legal requirements, the transaction may be flagged and a notification of failure may be communicated to the user 140, as in step 450. The failure notification may explain the reason for failure. Subsequently, the transaction database is updated with the transaction information, lender information for the transaction and approval decision, as in step 455. The process may be repeated for additional transactions, as in step 460, and several transactions by one or more users may be processed simultaneously. If there are no additional transactions, the process may end and the user may logoff for the current session, as in step 465.

Reporting tools may be provided to allow users to interactively interrogate the database, analyze its data and update it according to the user's privileges on data. The reporting tools may also allow the user to custom-design reports. A report can be previewed on a screen, printed onto paper or exported to one of several different file formats such as, for example, PDF, Microsoft® Excel, text or CSV. Report formats can vary from a simple column of values to layouts featuring pie charts, bar charts, cross-tab summary tables and nested sub-reports.

Customer service functions, steps and modules may be provided to ensure quality of service delivery for consumers and lenders by providing ready multi-lingual (e.g. English and Spanish) access to information, education, and issue resolution. Preferably highly qualified technical support and help desk support is available to respond within a determined service level to address any issues, monitor the system and provide several levels of support as required to maintain a secure and reliable processing environment. An interactive voice response unit available 24×7 may be provided as an integral part of the call center infrastructure to enables lenders and customers to access information and conduct business around the clock.

In sum, an exemplary computer-implemented system for credit transaction legal compliance according to principles of the invention includes a module for creating a user account for a user; a module for providing a source of law data applicable to credit transactions by the user; a module for receiving credit transaction data for a transaction by the user; a module for automatically comparing the credit transaction data for the transaction by the user with the law data applicable to the credit transaction by the user; and a module for determining whether the credit transaction data for the transaction by the user complies with the law data applicable to the credit transaction by the user. A module for providing a source of law data applicable to credit transactions by the user is configured to provide access to a source of law data, determine and encode requirements from the law data, including a transaction fee limit and a number of loans limit. A module for providing a source of law data may include associating law data with a state identifier and storing the law data and state identifier. A module for providing a source of law data may also include storing the law data applicable to covered members. A module for providing a source of law data may include periodically reviewing the law data. History of updates to the law data may be maintained. A module for creating a user account for a user may include receiving and storing lender information input from a user, the lender information including facility identification information. Ownership entity and facility identification information (e.g., the state(s) in which the entity and facility are located) is associated with credit transaction data for the transaction, thus enabling the governing state law to be determined. The credit transaction data includes borrower information, a transaction type datum, owner entity information, lender facility location information, a transaction date, a transaction amount, a transaction fee, an agreement date, a due date, a deposit date, a closed date, a return date and other fields as required to effectively ensure that the transaction complies with applicable law. Applicable legal requirements are determined based upon the credit transaction data, particularly facility location information and covered member status of the borrower. A module for automatically comparing the credit transaction data for the transaction by the user with the law data applicable to the credit transaction is configured to compare transaction data for the credit transaction with maximum legally allowable transaction data, and/or compare a credit transaction number for a borrower with a maximum legal number of credit transactions for a borrower, and/or compare the credit transaction data for the transaction by the user with the law data applicable to the credit transaction includes comparing a credit transaction number for a borrower for a determined period of time with a maximum legal number of credit transactions for a borrower for a determined period of time. A module for approval determination is configured to base a determination upon the comparison of the credit transaction data for the transaction by the user with the law data applicable to the credit transaction by the user, with the determination being approved if the credit transaction data complies with the law data applicable to the credit transaction and the determination being failed if the credit transaction data complies with the law data applicable to the credit transaction.

Likewise, in sum, an exemplary computer-implemented method for credit transaction legal compliance according to principles of the invention includes creating a user account for a user; providing a source of law data applicable to credit transactions by the user; receiving credit transaction data for a transaction by the user; automatically comparing the credit transaction data for the transaction by the user with the law data applicable to the credit transaction by the user; and determining whether the credit transaction data for the transaction by the user complies with the law data applicable to the credit transaction by the user. The step of providing a source of law data applicable to credit transactions by the user may include reviewing a source of law data, determining and encoding requirements from the law data, including, for example, a transaction fee limit and a number of loans limit. The step of providing a source of law data may include associating law data with a state identifier and storing the law data and state identifier. The step of providing a source of law data may further include associating law data with covered member status and storing the law data and covered member status identifier. The step of providing a source of law data may include periodically reviewing the law data. History of updates to the law data may be maintained. The step of creating a user account for a user may include receiving and storing lender information input from a user, the lender information including facility identification information. Ownership entity and facility identification information (e.g., the state in which the facility is located) is associated with credit transaction data for the transaction, thus enabling the governing state law to be determined. The credit transaction data includes borrower information, a transaction type datum, owner entity information, lender facility location information, a transaction date, a transaction amount, a transaction fee, an agreement date, a due date, a deposit date, a closed date, a return date and other fields as required to effectively ensure that the transaction complies with applicable law. Applicable legal requirements are determined based upon the credit transaction data, particularly facility location information. The step of automatically comparing the credit transaction data for the transaction by the user with the law data applicable to the credit transaction includes comparing transaction data for the credit transaction with maximum legally allowable transaction data, and/or comparing a credit transaction number for a borrower with a maximum legal number of credit transactions for a borrower, and/or comparing the credit transaction data for the transaction by the user with the law data applicable to the credit transaction includes comparing a credit transaction number for a borrower for a determined period of time with a maximum legal number of credit transactions for a borrower for a determined period of time. An approval determination is based upon the comparison of the credit transaction data for the transaction by the user with the law data applicable to the credit transaction by the user, with the determination being approved if the credit transaction data complies with the law data applicable to the credit transaction and the determination being failed if the credit transaction data complies with the law data applicable to the credit transaction.

While the invention has been described in terms of various embodiments and implementations, those skilled in the art will recognize that the invention can be practiced with modification within the spirit and scope of the appended claims. The invention is not limited to the exemplary steps and components described above. The selection, arrangement and configuration of components, and the selection and order of steps may be varied within the scope of the invention.

What is claimed is:

1. A computer-implemented method for credit transaction legal compliance, said method comprising:
creating a user account for a user;
providing a source of law data applicable to credit transactions by the user;
determining if the user is a covered member;
receiving credit transaction data for a transaction by the user;
automatically comparing the credit transaction data for the transaction by the user with the law data applicable to the credit transaction by the user;
determining whether the credit transaction data for the transaction by the user complies with the law data applicable to the credit transaction by the user; and
transmitting a response to the user indicating the compliance status of the transaction.

2. A computer-implemented method for credit transaction legal compliance according to claim 1, wherein the step of providing a source of law data applicable to credit transactions by the user comprises reviewing a source of law data.

3. A computer-implemented method for credit transaction legal compliance according to claim 2, wherein the step of providing a source of law data applicable to credit transactions by the user comprises determining and encoding requirements from the law data, said requirements including a transaction fee limit.

4. A computer-implemented method for credit transaction legal compliance according to claim 3, wherein the step of providing a source of law data applicable to credit transactions by the user comprises determining and encoding requirements from the law data, said requirements including a number of loans limit.

5. A computer-implemented method for credit transaction legal compliance according to claim 4, wherein the step of providing a source of law data comprises associating law data with a state identifier and a covered member status and storing the law data and state identifier.

6. A computer-implemented method for credit transaction legal compliance according to claim 5, wherein the step of providing a source of law data comprises periodically reviewing the law data.

7. A computer-implemented method for credit transaction legal compliance according to claim 6, further comprising maintaining a history table of updates to the law data.

8. A computer-implemented method for credit transaction legal compliance according to claim 7, wherein the step of creating a user account for a user comprises receiving and storing lender information input from a user, the lender information including facility identification information.

9. A computer-implemented method for credit transaction legal compliance according to claim 8, further comprising associating ownership entity and facility identification information with credit transaction data for the transaction.

10. A computer-implemented method for credit transaction legal compliance according to claim 1, wherein the credit transaction data includes borrower information, a covered member status datum, a transaction type datum, owner entity information, lender facility location information, a transaction date, a transaction amount, a transaction fee, an agreement date, a due date, a deposit date, a closed date, and a return date.

11. A computer-implemented method for credit transaction legal compliance according to claim 10, determining applicable legal requirements based upon the credit transaction data.

12. A computer-implemented method for credit transaction legal compliance according to claim 10, determining applicable legal requirements based upon the lender facility location information and the covered member status datum.

13. A computer-implemented method for credit transaction legal compliance according to claim 1, wherein the step of automatically comparing the credit transaction data for the transaction by the user with the law data applicable to the credit transaction includes comparing a transaction fee for the credit transaction with a maximum legal transaction fee.

14. A computer-implemented method for credit transaction legal compliance according to claim 1, wherein the step of automatically comparing the credit transaction data for the transaction by the user with the law data applicable to the credit transaction includes comparing a credit transaction number for a borrower with a maximum legal number of credit transactions for a borrower.

15. A computer-implemented method for credit transaction legal compliance according to claim 1, wherein the step of automatically comparing the credit transaction data for the transaction by the user with the law data applicable to the credit transaction includes comparing a credit transaction number for a borrower for a determined period of time with a maximum legal number of credit transactions for a borrower for a determined period of time.

16. A computer-implemented method for credit transaction legal compliance according to claim 1, wherein the step of automatically comparing the credit transaction data for the transaction by the user with the law data applicable to the credit transaction includes comparing a credit transaction number for a borrower with a maximum legal number of credit transactions for a borrower, and comparing the credit transaction data for the transaction by the user with the law data applicable to the credit transaction includes comparing a credit transaction number for a borrower with a maximum legal number of credit transactions for a borrower, and comparing the credit transaction data for the transaction by the user with the law data applicable to the credit transaction includes comparing a transaction fee for the credit transaction with a maximum legal transaction fee.

17. A computer-implemented method for credit transaction legal compliance according to claim 1, further comprising making an approval determination based upon the comparison of the credit transaction data for the transaction by the user with the law data applicable to the credit transaction by the user.

18. A computer-implemented method for credit transaction legal compliance according to claim 1, further comprising making an approval determination of approved or failed based upon the step of automatically comparing the credit transaction data for the transaction by the user with the law data applicable to the credit transaction by the user, with the determination being approved if the credit transaction data complies with the law data applicable to the credit transaction.

19. A computer-implemented method for credit transaction legal compliance according to claim 1, further comprising making an approval determination of approved or failed based upon the step of automatically comparing the credit transaction data for the transaction by the user with the law data applicable to the credit transaction by the user, with the determination being failed if the credit transaction data does not comply with the law data applicable to the credit transaction.

20. A computer-implemented method for credit transaction legal compliance according to claim 1, further comprising making an approval determination of approved or failed based upon the step of automatically comparing the credit transaction data for the transaction by the user with the law data applicable to the credit transaction by the user, and providing a notice of the determination to the user.
